(19) United States
(12) Patent Application Publication
(10) Pub. No.: US 2006/0080613 A1
(43) Pub. Date: Apr. 13, 2006

(54) System and method for providing an interactive social networking and role playing game within a virtual community

(76) Inventor: Ray Savant, New York, NY (US)

Correspondence Address: Fay Kaplun & Marcin, LLP;Suite 702, 150 Broadway, New York, NY, 10038, US

(21) Appl. No.: 10/963,297

(22) Filed: Oct. 12, 2004

(51) Int. Cl. G06F 3/00; G06F 17/00

(52) U.S. Cl. 715/745; 715/733

(57) ABSTRACT

Described is a system and method for receiving personal profile data from a plurality of participants, wherein each participant is a member of a virtual community. Generating a participant profile for each of the participants as a function of the personal profile data corresponding to each participant, rating each participant as a function of an activity level within the virtual community and providing additional features to participants achieving a pre-determined rating.

### BACKGROUND INFORMATION

The development of computer and networking systems (e.g., Internet) has enabled people to form social interactions and networks from their desks. One method of promoting social interactions and networks within a computer networking system is by forming virtual communities. A virtual community comprises a plurality of users who communicate with each other and contribute content to bind users together as a social entity and/or foster individual relationships. Some embodiments of virtual communities have been online dating sites (e.g., Lavalife, Match.com), online “blogging” sites (e.g., Xanga, Live Journal), rating sites, direct messaging site (e.g., Instant Messenger) and avatar sites.

Traditional virtual communities have generated revenue by selling advertising, charging a flat membership rate or charging a flat rate per communication. These business models do not capitalize on the amount of communications generated and/or the desirability of the content provided by the virtual community. It does not give any means for users to distinguish their sincerity and desire to communicate with each other. For advertising and flat membership rate business models, the systems do not capitalize on the interactions between users. The sponsors generate the same amount of revenue whether users send many or few communications. Although a flat rate per communication may reflect the amount of communications, it does not demonstrate the desirability and strength of relationships. Every communication is valued the same whether they are desirable or not.

Online greeting card sites may charge differently based on the card purchased, demonstrating the strength of the relationship between two parties. However, online greeting card sites do not contain virtual communities. Each virtual card is an isolated transaction. Users do not foster a community and build relationships with each other. Rather, most users of online greeting card sites transmit cards to others who have already formed pre-existing relationships with them.

Although there have been many pre-existing embodiments of virtual communities for social interactions and networking, all of them have neglected to ask users to assume roles within a designated social setting. There have been online role playing games where players assume roles and identities such as super heros, mystical creatures, villains, or other unrealistic and fantastic roles, none of which are related to roles within an online parallel of actual social settings.

Accordingly, a need exists, in the context of virtual communities, for a system and method that overcomes the shortcomings of conventional virtual communities, particularly as to an online role playing game where players assume realistic roles within a social setting and a method to generate revenue based on the amount and the desirability of the social interactions and networking of these players.

### SUMMARY OF INVENTION

The present invention relates to a method and system for providing an interactive social networking and role playing game within a virtual community. Personal profile data is obtained from a plurality of participants of a virtual community. A participant profile is generated for each of the participants as a function of the personal profile data corresponding to each participant. The participants may engage in the virtual community by sending gifts acquired from a virtual gift shop within the virtual community. Then, each participant is rated as a function of an activity level, measured by an amount of gifts acquired from the virtual gift shop, corresponding to each participant. Participants who achieve a pre-determined rating are then provided with additional features within the virtual community.

In addition, a method of receiving personal profile data from a plurality of participants, wherein each participant is a member of a virtual community, generating a participant profile for each of the participants as a function of the personal profile data corresponding to each participant, rating each participant as a function of an activity level within the virtual community and providing additional features to participants achieving a pre-determined rating.

A system including a registration element configured to receive personal profile data from a plurality of participants, wherein each participant is a member of a virtual community, a profile element configured to generate a participant profile for each of the participants as a function of the personal profile data corresponding to each participant and a rating element configured to rate each participant as a function of an activity level within the virtual community; wherein additional features are accessible to participants achieving a pre-determined rating.

Moreover. a method of storing a plurality of virtual representations of actual gifts, displaying the virtual representations, receiving an order for one of the virtual representations from a participant in a virtual community, charging the participant for the one of the virtual representations and fulfilling the order for the one of the virtual representations.

### BRIEF DESCRIPTION OF DRAWINGS

FIG. 1 shows an exemplary embodiment of a system according to the present invention for providing an interactive social networking and role playing game within a virtual community.

FIG. 2 is an exemplary embodiment of the user interface 200 according to the present invention for providing an interactive social networking and role playing game within a virtual community.

FIG. 3 is an exemplary embodiment of the process for a participant to access the present invention for providing an interactive social networking and role playing game within a virtual community.

FIG. 4 is an exemplary embodiment of a method according to the present invention for providing an interactive social networking and role playing game within a virtual community.

### DETAILED DESCRIPTION

The present invention may be further understood with reference to the following description and the appended drawings, wherein like elements are provided with the same reference numerals. The present invention includes a system and method for providing an interactive social networking and role playing game within a virtual community.

Traditional online social interactions between participants within a virtual community have poorly imitated reality and have failed to mimic many features of an actual social setting, which drives people to compete for attention. Relationships between individuals may vary in strength. Traditional online social networking systems and methods do not reflect the popularity of a single participant within the virtual community. Furthermore, they do not permit third-parties from observing the strength of individual relationships. Within the traditional online format, all participants are treated equally by the system and are not differentiated based on popularity, desirability, amount of use, or other real-world parallels for differentiating social interactions.

Furthermore, traditional online social networking systems and methods have failed to charge participants based on the amount of use and the desirability of the service provided. For example, traditional systems have failed to charge based on the number of messages sent and also on the desirability of the system's content (e.g., the desire of one participant to communicate and interact with another within the system). Some traditional online social networking systems generate revenue based on advertising or flat fees, both of which, do not reflect the social interactions. Although some systems have utilized a charge per use system, they, however, fail to reflect the desirability of these social interactions. For example, Lavalife.com utilizes tokens for communications between participants. Each token costs the same. A communication between any two participants costs one token, regardless of the participant's desirability or popularity.

The present invention offers a system and method for social networking which better reflects the activities and traits of an actual group social setting. The present invention reflects the strength of the relationship between two participants and identifies the most active and/or desirable participants. Furthermore, the present invention provides incentives for participants to impress one another with materialistic goods or services, whether it is real or virtual, similar to everyday life. For example, one may purchase jewelry or virtual (e.g., digital) representations thereof as a token of affection. The present invention encourages participants to give gifts and communicate to raise the level of participation of other participants, particularly those associated with him/her. In addition, the applicants' invention permits third-party observers to review the communications and the gifts transferred between participants and assess the strength of the relationships. Furthermore, the present invention incorporates a competitive scheme where participants strive to become the focus of the social network. This feature of the applicants' invention parallels actual social settings where people compete to become the sole focal point (e.g., beauty pageants, talent shows, reality shows). Participants who reach the top of particular categories are portrayed in prominent areas of the user interface of the present invention. These top participants may become the “spotlight” of the user interface, draw attention to themselves, and gain public exposure. Participants may be driven to compete to achieve such goals.

The preferred embodiment of the present invention will be described as an online parallel of an exclusive after-hours style club. However, it should be understood that, although the preferred embodiment of the present invention will be described as an online parallel of an exclusive after-hours style club, the present invention may be implemented to parallel a wide range of social settings including, for example, a house party, bar, concert, classroom, coffee shop, awards ceremony, formal gala, workplace, etc. Furthermore, the term “virtual communit” will be used through out this description to generically refer to all online parallels of such types of social settings.

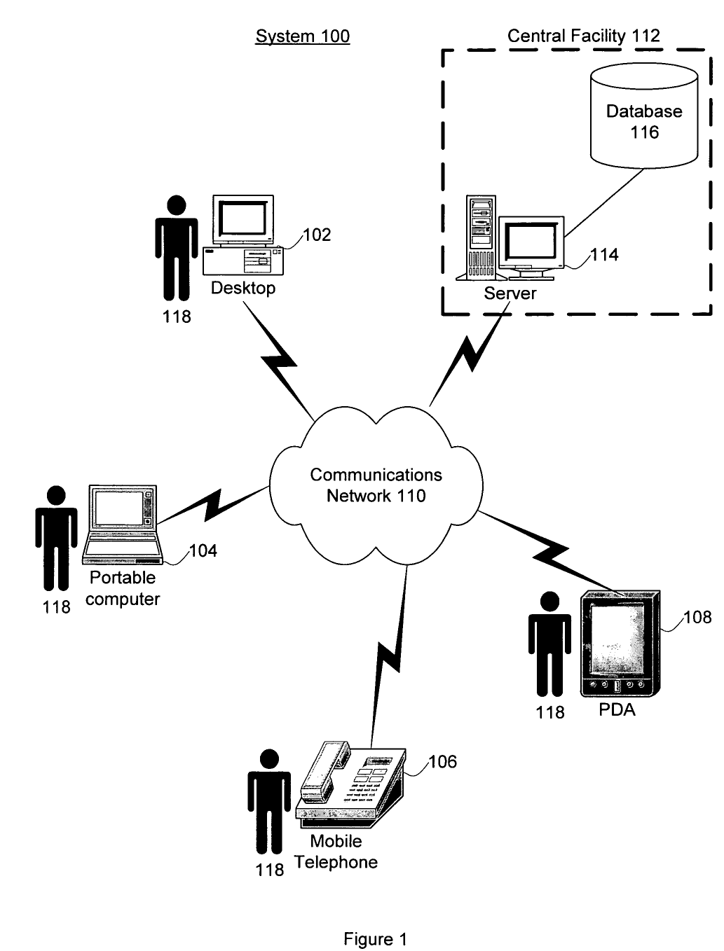

FIG. 1 shows an exemplary embodiment of a system 100 according to the present invention for providing an interactive social networking and role playing game within a virtual community. The system 100 may include a plurality of computing devices which include communication devices to connect to a communications network. The computing devices may include, for example, a Personal Digital Assistant (PDA) 108, a cellular telephone 106, a portable computer 104, a desktop computer 102, and a pager (not shown). These portable communication devices are connected to a central facility 112 via a communications network 110. The computing devices may be located anywhere. The communications network 110 may, for example, include the Internet, a cellular network, a satellite network, a wide-area network (WAN), a local-area network (LAN), etc.

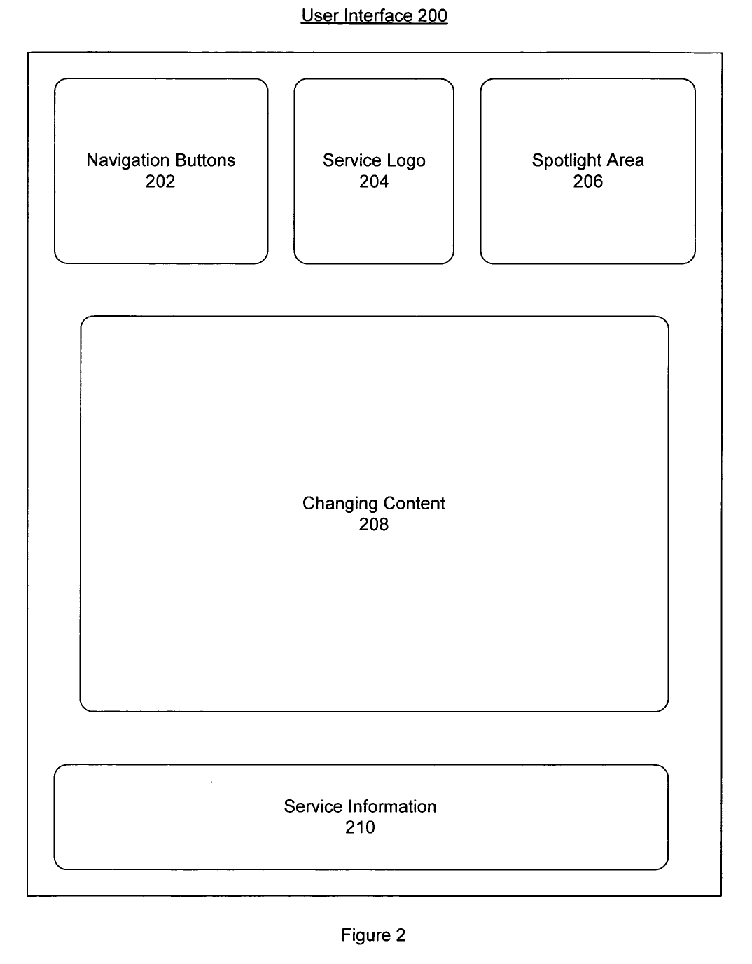

The central facility 112 may host a user interface 200 (FIG. 2) and process and/or store all participants' information and communications. The central facility 112 may, for example, include one or more servers 114 connected to one or more databases 116 where a variety of data may be stored, e.g., participants' information, communications content data, etc. The central server 114 may host the user interface 200, which is used to communicate with and transfer data to participants 118. For example, the user interface 200 may be a web page hosted by a web server on the central server 114. Each of the computing devices 102-108 may include a web browser for accessing the user interface 200. In addition, the central server 114 may process and direct all traffic within the central facility 112. The central server 114 may restrict access to some or all of the data within the system 100. For example, non-registered users may have extremely limited access to the data stored within the central facility 112. They may, for example, be permitted to only access the initial interface (e.g., registration screen, home page, start page) of the user interface 200. However, registered participants may be permitted access beyond the initial interface and review data stored within the central database 116. In addition, there may be, for example, additional levels of access distinguished between registered participants. Upon fulfilling some additional requirements, a participant 118 may be permitted to access more data, as compared to the initially registered participant (e.g., special content, restricted content, additional purchased access). Those of skill in the art will understand that it may also be possible to set up the system 100 as a peer-to-peer network, e.g., where the individual computing devices store any applications and data and the central facility 112 is used for the purpose of maintaining access lists, monitoring content, moderating groups, etc.

FIG. 2 is an exemplary embodiment of the user interface 200 according to the present invention for providing an interactive social networking and role playing game within a virtual community. The user interface 200 for example, may include an initial user interface, subsections designated to display one or more categories of content, and individual pages within the subsections where the contents are displayed. Terms used within the user interface may correspond to the casual language used within the social setting that the virtual community parallels. For example, in an exclusive after-hours club, the language used may include “star,” “VIP,” “velvet rope.” Every page of the user interface 200 may include two types of display areas: (1) consistent areas 202, 204, 206, 210 and (2) dynamic areas 208.

Consistent areas remain the substantially similar (i.e., same location, same type of content, similar layout) throughout every page of the user interface 200. Consistent areas in this exemplary embodiment may be located at the top and/or bottom of each page of the user interface 200. Consistent areas may include, for example, navigation buttons 202, a service logo area 204, a spotlight area 206 and service information 210. The navigation buttons 202 may direct participants 118 to different subsections or pages of the user interface 200. The different subsections may communicate and/or transmit different sets of data stored within the central database 116, allowing the participant 118 to view varying content. The service logo area 204 may be occupied by any type of data. Generally, the service logo area 204 would be occupied by image(s) and/or text which indicate or represent a corporate entity or service product. The represented corporate entity or service product will often be related to the sponsor(s) of the system 100. The service logo area 204 may remain the same through out different pages of the user interface 200. In the alternative, the service logo area 204 may vary between different pages, where the data portrayed in the service logo area 204 relate to the page content. The spotlight area 206 may portray participants 118 who have achieved specific pre-determined goals. Only a selected few participants 118 may be displayed within the spotlight area 206. The manner in which a participant 118 may achieve a place within the spotlight area 206 will be further discussed in detail below. The spotlight area 206 may have the same participants 118 spotlighted on all pages of the user interface 200. Alternatively, the spotlight area 206 may have different participants 118 spotlighted on different pages and the spotlighted participant 118 may be related to the page content. The service information area 210 may, for example, include terms of service, information regarding the service, legal notices, buttons that redirect to other pages, etc.

The dynamic areas 208 within every page of the user interface 200 are areas where the data displayed changes from page to page. Participants 118 may desire to view different data as they navigate through the user interface 200. As the participant 118 navigates through the different pages of the user interface 200, data corresponding to the selected page of the user interface 200 may be requested from the central database 116. The data requested may be integrated into the user interface 200 and displayed within the dynamic areas 208.

Furthermore, the user interface 200 may display and transmit data to participants 118 in multiple languages. The communications network 110 may reach places where different languages are spoken. For example, the Internet reaches many different countries and includes users who may speak English, Spanish, French, etc. Enabling support for multiple languages within the user interface 200 broadens the scope of potential participants for the present invention. Furthermore, multiple language support may enable participants 118 who speak different languages to interact and socially network with each other. Multiple language support may allow participants 118 from various cultures to interact and form a more diverse virtual community. For example, with multiple language support, a participant 118 from the United States, who speaks English, may be able to communicate and interact with another participant 118 in Mexico, who speaks Spanish.

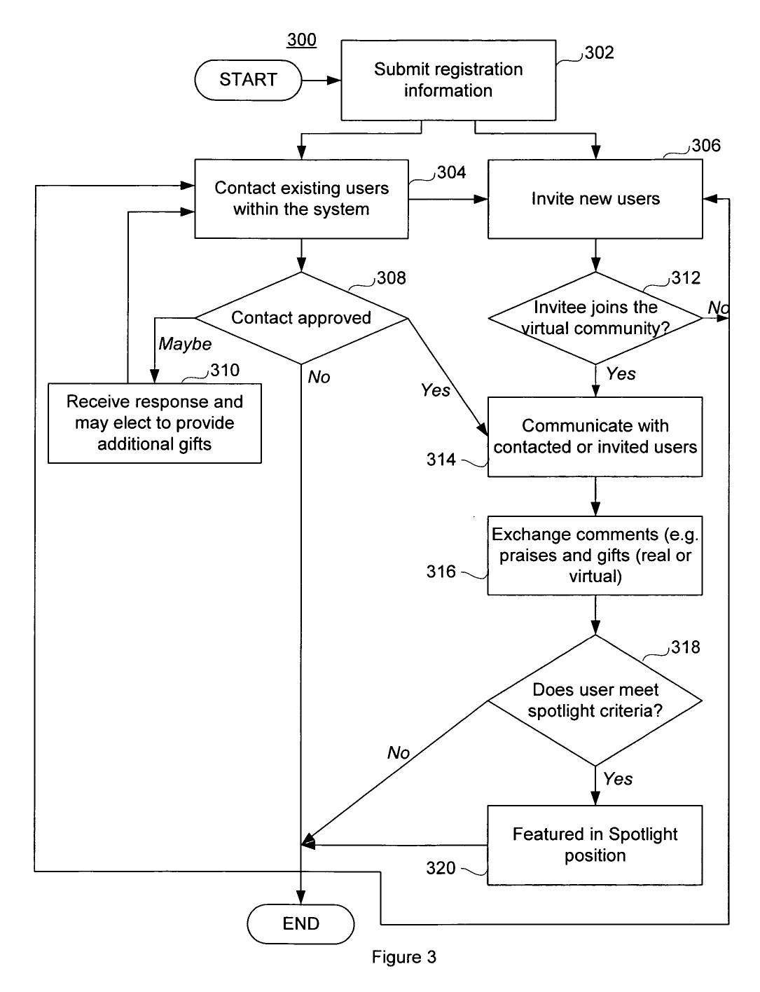

FIG. 3 is an exemplary embodiment of the process 300 for a participant 118 to access the exemplary embodiment of the present invention for providing an interactive social networking and role playing game within a virtual community. As stated above, non-registered users may only have limited access and may, for example, be permitted to access only the initial interface. Therefore, in order to access the exemplary embodiment of the present invention and participate in the interactive social networking and role playing game, one must become a registered participant 118.

To become a registered participant 118, one must submit registration information (step 302). Registration information may include, a participant identification, a password, a participant photograph, personal information, a selected social role, role playing game information, a profile message, etc. The registration information may further include the participant's payment information. After the initial registration, an existing participant 118 may continue to modify or add information to the registration information. Upon authentication, the participant 118 may view or update his/her own profile and/or registration information. In a preferred embodiment, all payment information and transactions are sent and viewed securely.

For example, the participant 118 may select any combination of letters and numbers to create a participant identification code. The selected participant identification code becomes associated with the participant 118 and all of his/her corresponding information and data. The participant identification code functions as the “name” of the participant 118 within the present invention. The participant 118 will be addressed by and known to others only as the participant identification code and not his/her actual name.

As discussed above, the central server 114 may restrict access to some or all of the data within the system 100. Therefore, it is necessary to employ means to distinguish the levels of access available to different participants 118. One exemplary means for distinguishing the levels of access available to different participants 118 is by using an account and password. Each participant's data and access permissions may be associated with his/her own account. Every account may be granted permission to access a general pool of data. However, if the participant 118 meets certain additional requirements (e.g., have sent more than a designated amount of gifts, have received more than a designated amount of gifts, have paid for additional access, etc.), then the participant 118 may be permitted to access further data.

The submitted registration data and any other information associated with the participant's account (e.g., access level, etc.) may be stored, for example, in the database 116 of the central server 114. Prior to acquiring content data from the central database 116, the participant 118 must first be authenticated. For example, the participant 118 may be authenticated by providing his/her participant identification code and the corresponding password which the participant 118 may select during the registration process of step 302. The server 114 may access the database 116 to verify the usemame/password information and set up a user session for the participant 118 based on the information stored for the participant's account.

Other information that the participant 118 may provide during the registration process or subsequent updating may include one or more photographs portraying him/herself. The photographs associate the participant identification code with actual photographs of the participant 118. The photographs provide for a more realistic portrayal of actual social interactions and communities because they allow participants 118 to associate human faces with an artificial “name,” the participant identification code. Furthermore, if participants 118 later choose to physically meet and interact with each other outside of the present invention, the photographs may aid participants 118 in identifying each other.

Step 302 may also include the registration of participant personal information. The personal information may include, for example, email, country of residence, state of residence, city of residence, zip code, gender, sexuality, birth date, zodiac sign, relationship status and ethnicity. The personal information may be used to create a participant profile. Some or all of the personal information provided may be included within the participant profile. Each participant's profile may be accessed and viewed by other participants 118. For privacy reasons, certain personal information may be withheld from the profile which may be viewed by other participants.

During registration, the participant 118 may assume a social role for the interactive role playing game according to the exemplary embodiment of the present invention. The roles may include adventurer, artist, barbarian, bartender, biker, cowboy, dancer, DJ, fitness star, joker, model, monk, news anchor, nurse, pop star, raver, renaissance man, rock star, soldier, surfer, villain, wrestler, etc. In addition to selecting a role, the participant 118 may also provide additional details regarding his/her character such as, for example, physical traits, personality, skills and gifts desired. Physical traits may include dimples, freckles, muscular, piercings, etc. Personalities may include aggressive, competitive, jealous, quiet, shy, talkative, etc. Furthermore, skills may include driving, cooking, photography, telling jokes, etc. The participant 118 may also create a wish list for gifts desired. The gifts may be selected from a list of available gifts within the system 100.

The participant 118 may elect to provide a message to all who view his/her profile. This message may be created during the registration step 302. The message may include, for example, text, images, audio and/or videos. Within this message, the participant 118 is free to create a message that reflects and expresses his/her creativity and personality.

In addition, the participant 118 may further provide his/her payment information (e.g., credit card number, billing address, debit account number, etc.) during registration. The participant payment information is preferably associated with the participants' account and is only accessible upon authorization.

Once the participant 118 completes the registration process he/she may contact existing participants 304 or invite potential new participants to the virtual community 306. In step 304, a participant 118 may search or browse profiles of existing participants and select participants to contact. Participants 118 may search or browse existing profiles using fields within the profiles, more specifically, using the participants' personal information. For example, one may search only for participants 118 who assumed specific roles and live within a specific locale. In this exemplary embodiment, the participant 118 may cast a vote in favor of another participant and/or choose to send an invitation to the other participant for communications as a manner of contacting existing participants. Once an existing participant is selected, the participant 118 may create and send an invitation. The invitation may include text, images, audio and/or video expressing the participant's message to the existing participant. Furthermore, the participant 118 may include along with the invitation, gift(s) that may be purchased from the system 100. The method of gift purchases according to the present invention will be further discussed below. The gifts may serve as a token of sincerity or affection and may indicate the participant's desire to communicate with the existing participant. Upon receipt of the invitation, the existing participant may respond in one of three ways: (1) Yes; (2) No; or (3) Maybe (step 308). If the existing participant elects to respond with “Yes”, then the participant 118 would be permitted to communicate with the invitee and be granted permission to access the invitee's inner community (step 314). If the invitee elects to respond with “No”, then the participant 118 would be denied permission to communicate with the invitee. In addition, the participant 118 will not be permitted to access additional data related to the existing participant who denied the participant's request for contact. Such a rejected participant may continue to contact existing participants (step 304) or invite new participants (step 306).

A response of “Maybe” in step 308 will also not permit the participant 118 to communicate with the existing participant or access the additional data. However, the decision is not final. A response of “Maybe” indicates that the invitee found the participant's invitation lacking and wishes that the participant 118 would try again. As indicated in step 310, the participant 118 may send a new invitation which may include new text and/or additional gifts. Additional gifts may further indicate the participant's sincerity and desire to communicate with the invitee, but it is not necessary. Upon receipt of the new invitation, the invitee may once again choose one of the three responses. If the invitee selects a response of “Maybe,” then step 310 may repeat until the invitee selects definitive answer (i.e. “Yes” or “No”) or the participant 118 refuses to send further invitations to that particular existing participant.

In step 306, the participant 118 may invite others to join the virtual community. For example, there may be a subsection for creating invitations to potential new participants within the user interface 200. The participant 118 may complete the forms within this invitation section of the user interface 200 and invite others to become registered participants of the virtual community. The invitations may be forwarded via the communications network 110 or in traditional manners. For example, the invitations may be forwarded by electronic mail (e-mail), traditional postal mail, messenger mail, cellular text message, or any other form of messaging. The invitee may choose to accept or decline the invitation (step 312). In this exemplary embodiment, if the invitee becomes a new registered participant of the virtual community, the inviting participant 118 and the invitee may be automatically granted permission to communicate with each other and participate in each other's inner communities (step 314).

The participant 118 may be granted permission to communicate with the invitee and take part in his/her inner community, whether the invitee had been an existing participant or a new registrant (step 314). After obtaining permission for additional access and communications, the participant 118 may communicate with the other participants through private or publicly viewable messaging (step 316). These messages may be stored within the central database 116 and associated with the participant's account and profile. Private messages may include private messaging via the user interface 200, e-mail, cellular text messaging, or any other means of one-to-one messaging over a communications network 110. Private messages are viewable only by the sender and recipient. Publicly viewable messaging, however, may be viewed by anyone with permission to access the user interface 200. Publicly viewable messaging may include electronic forums, electronic message boards, publicly viewable messaging via the user interface or any other means of publicly viewable messaging over a communications network 110. There may be multiple types of publicly viewable messaging between participants 118. For example, publicly viewable messaging may include purely text communications between participants 118, praises with attached point values, and messages along with gifts. Third parties are permitted to access publicly viewable messages along with the point values and/or gifts attached. Because these messages may be associated with the participant's profile and are publicly viewable, participants 118 may be encouraged to solicit for points and/or gifts from other participants. Furthermore, participants 118 may desire for large amounts of points and/or gifts to demonstrate to all third party viewers that he/she is desirable and popular. Other limited types of publically viewable messages may also be available e.g., only to those in a specific community or set of communities.

A participant's inner community may include those other participants who have been invited or authorized by the participant 118 for communications. The inner community may be permitted to access additional data as compared to an initially registered participant. The additional data may, for example, include message forums, chat rooms, electronic message boards, videos, audio clips, or other forms of electronic media, all of which are exclusive and limited only to invited or authorized participants. Because the additional data are exclusive and limited in access, participants 118 may desire and compete to become members of inner communities which include data they find desirable. The behavior of participants 118 in this virtual community is similar to actual interactions within an exclusive after-hours club, where club-goers compete to be recognized and associated with the desirable club-goers (e.g., the popular, attractive, famous).

Within the interactive role playing game according to the present invention, the participants 118 may compete to reach Premium status. Participants 118 who reach Premium status may be, for example, featured in a prominent area within the user interface 200, such as, for example, the spotlight area 206 or on the initial interface, drawing attention to these participants and providing them with publicity (steps 318 and 320). Whether a participant 118 reaches Premium status may depend, for example, on the amount of points and gifts he/she has received. In this exemplary embodiment, votes from other participants, amount spent on gifts for others and other valuation methods may also be utilized for determining Premium status. Additional criteria may also be used to identify Premium participants. For example, birthday, registration anniversary and other criteria which may be significant to participants in the virtual community.

If the participant 118 meets the criteria for the Premium status (e.g., most amount of gifts received, most amount of money spent on gifts, most points in praises, etc.), then the participant 118 may be portrayed (i.e., image and/or name of the participant displayed) in one of the prominent areas. The prominent areas provide Premium participants with more public. exposure. The spotlight area 206 is repeated within every page of the user interface 200, enabling some Premium participants to be viewed by every participant of the virtual community. In the alternative, Premium participants may be portrayed on the initial interface. For example, in addition to the spotlight area 206, the dynamic area 208 of the initial interface would also feature Premium participants. The initial interface is the first page of the user interface 200 encountered by all users. Generally, every registered participant may need to access the initial interface to authenticate him/herself for further access to the data stored within the central database 116. Furthermore, an unregistered user may access only the initial interface. Therefore, the initial interface is a frequently accessed page viewed by all users (registered and unregistered) and is also suitable for “featuring” Premium participants.

The registered participant may continue to contact existing participants 304, invite new participants 306, and exchange comments and gifts 316 with previously approved invitees. As the participant continues to role play within the virtual community according to the present invention, the participant's points, gifts, votes received, amount spent, and other means for valuation may change. Other criteria used for Premium status may also change. As the above-listed factors change, the participant's Premium status may be adjusted appropriately to accurately reflect the competition within the virtual community.

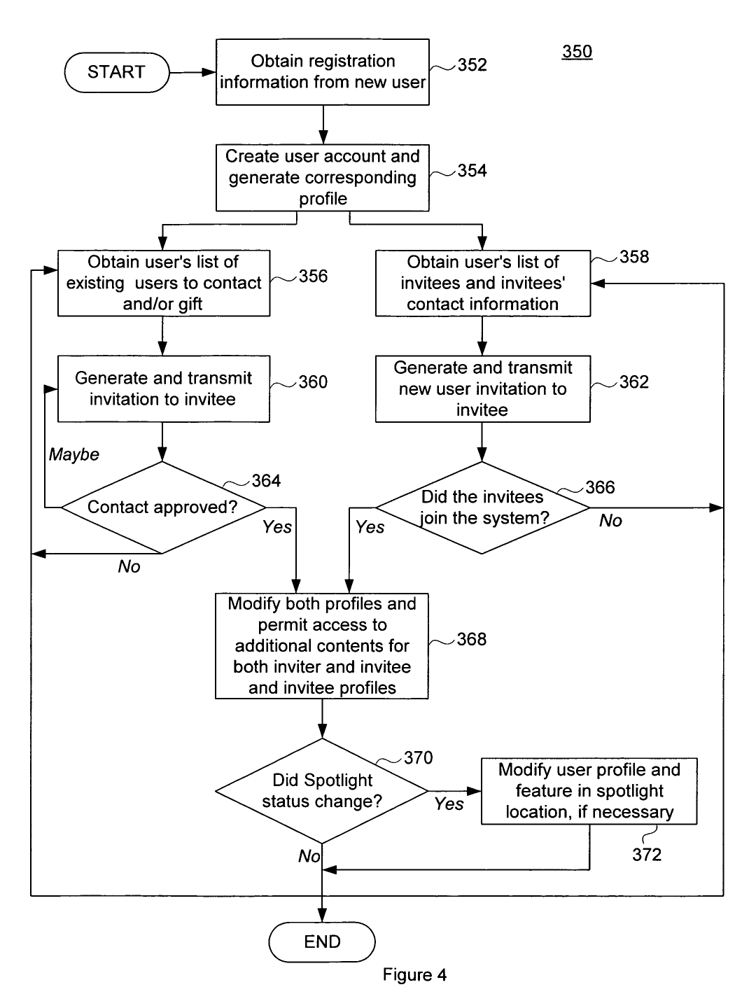

FIG. 4 is an exemplary embodiment of a method 350 for providing an interactive social networking and role playing game based within a virtual community. As new participants become members of the virtual community, registration information from the new registrant is collected (step 352). The registration information may be the same type of information described above with reference to step 302 of FIG. 3, for example, a participant identification code, a password, personal information, role selected, role playing information, etc. Furthermore, the registration information may include the participant's payment information. An account may be created based on the participant identification code and password. Each account is only accessible to the authorized participant. A participant 118 may, for example, only access his/her account after correctly providing the participant identification code and the corresponding password to authenticate his/her identity. Preferably, the participants' payment information is associated with the corresponding participant identification code and account.

Within each account, a corresponding profile may be generated based on the registration data (step 354). Some or all of the registration data may be used to generate the participant's profile. The generated profile may be stored within the central database 116. The profile becomes accessible for other participants to search and browse. For example, the profile may become one of many profiles in a gallery of participant profiles. Information contained within the profiles may be used as search terms to narrow the list of participants and select only those who possess certain traits.

The participant 118 may contact existing participants 304 or invite others to become new participants of the virtual community 306. If the participant 118 elects to contact existing participants, then according to step 356, a list of selected existing participants and corresponding gifts offered, if any, may be obtained from the participant. For each existing participant selected, an invitation, which may, for example, include customized text, video, audio, images and/or gifts may be generated and transmitted to the invitee (step 360). Upon receipt of the invitation, the invitee may decide whether or not to accept the invitation (step 364). If the invitee accepts the invitation, then the method 350 may proceed to step 368. If the invitees declines the invitation, then no further action may be required. However, the participant 118 may choose to invite others and a new list of invitees may be obtained 356. If the invitee respond to the invitation with the response “Maybe,” then the response is forwarded to the participant 118. If the participant 118 continues to pursue the same invitee, a new invitation may be generated and transmitted to the invitee along with corresponding gifts, if any (step 360). Step 360 may be repeated until the invitee provides a definitive response (i.e., yes or no).

If the participant 118 elects to invite others to become new participants, then according to step 358, a list of new invitees and their contact information may be obtained from the participant 118. Based on the contact information provided, a new participant invitation is generated and transmitted to the invitee (step 362). For each potential new participant invited by the participant 118, customized text, video, audio and/or images may be obtained. The data obtained from the participant 118 along with an explanation of the social networking and/or role playing game may be compiled into an invitation and transmitted to the invitee. The invitee may choose to accept or decline the invitation (step 366). If the invitee accepts the invitation, new registration information may be obtained from the invitee and the method 350 may proceed to step 368. If the invitees declines the invitation, then no further action may be required. However, the participant 118 may choose to invite others and a new list of invitees may be obtained (step 358).

In step 368, both the invitee (whether they are new participants from step 366 or existing participants from step 364) and the participant's profiles may be modified to reflect the new relationship formed between the parties. The participant's profile may reflect that he/she is permitted to communicate with the invitee and vice versa. Furthermore, the participant's account may be granted access to the invitee's inner community while the invitee's account may be granted access to the participant's inner community. Both parties may be encouraged to send messages to each other and participate in each other's inner communities, such as posting in forums, communicating in chat rooms, providing exclusive digital media clips, etc. In addition, both parties may be encouraged to purchase and send gifts from the gift shop within the present invention. As participants 118 interact with each other, their profiles may be modified. For example, participants 118 may gain more votes, more members within their inner community, more approvals, more praises, more points, or other criteria for Premium status. Therefore, it is necessary to check whether or not the participant's new statistics qualify him/her for Premium status (step 370). If the participant 118 qualifies for Premium status, then the participant 118 is featured either in a prominent location, such as the spotlight area 206 within the pages of the user interface 200 or the initial interface (step 372). If the participant 118 had previously qualified for Premium status but has since failed to meet the qualifications, then the participant may be removed from the prominent locations.

As referred to above, participants 118 may purchase gifts for other participants from a virtual gift shop within the user interface 200 according to the exemplary embodiment of the present invention. Participants 118 may access and purchase gifts from the virtual gift shop any time after providing the registration information 302. The virtual gift shop may be, for example, an online entity that participants 118 access via a communications network 110. Participants 118 may purchase gifts from the virtual gift shop for other participants or him/herself. Gifts purchased and/or received by members of the virtual community may be, for example, recorded in the participants' profiles to reflect their desirability and popularity. Records of gifts purchased and/or received by participants 118 may be private or publicly accessible.

In this exemplary embodiment, products sold within the virtual gift shop may include actual goods or services and/or virtual representations of goods or services. For example, a gift may be a car, flowers, gift cards to actual stores, gift cards to the virtual gift shop, magazines, a massage, a book, clothing, an image, a video, an icon, an audio clip, etc. Tangible goods may be transported to the recipient by a delivery service. The location of the recipient may be ascertained from the his/her registration information. Virtual gifts may be transmitted to the recipient via the communications network 110.

Alternatively, a gift may also provide access to additional features or services within the virtual community. For example, certain gifts may unlock special features which permit the participant to enjoy additional services within the virtual community that would not be otherwise available (e.g., increased image or video storage, ability to utilize certain gifts, ability to be featured in a prominent area of the user interface 200 without having to compete, etc.). Furthermore, some exemplary gifts may include interactive games. The games may include lottery tickets, slot machines, poker, roulette, puzzles, adventure games, arcade games, etc. In an exemplary embodiment, the interactive games may include parlor games (i.e., poker, slot machine, roulette, lottery ticket) where participants have the opportunity to win items from the virtual gift shop.

According to the present invention, participants 118 are not required to physically enter specific locations in order to purchase gifts for other participants. The virtual gift shop may be, for example, accessible from anywhere in the world. Furthermore, the virtual gift shop may support multiple languages. Because the virtual community may include people who speak various languages, multiple language support will enable more participants, if not all, to browse the virtual gift shop. In addition, the virtual gift shop may also accept multiple currencies (e.g. U.S. Dollar, Japanese Yen, Euros). By accepting multiple currencies, the virtual gift shop allows participants 118 to shop using their native currency. Participants 118 would not need to worry about currency conversions and can shop with ease.

Payment for gifts purchased may be provided prior, during, or subsequent to the sale. For example, participants 118 may pre-pay for specific amounts and with each purchase, the value of the gift is deducted from the pre-pay amount. However, participants 118 may pay subsequent to the sale. For example, the participant 118 may be charged periodically, at the end of each period, for the amount of purchases made during that period. In the alternative, participants 118 may also pay during the sale. For example, participants 118 may provide payment during the purchase. Payment may be tendered by recalling the payment information previously provided during the registration process, obtaining the payment information from the participant, or deducting from virtual gift shop gift cards received. Payments may be provided via a communications network 110 or by traditional means (i.e. mail or in-person). Payments via the communications network 110 may be provided with credit cards, debit cards, checking accounts, Paypal accounts, gift cards or other means of transferring money via the communications network 110. In a preferred embodiment, payment may be transferred securely over the communications network 110. As one skilled in the art would ascertain, secure transfers may, for example, include encryption and security certificates.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed:

1. A method, comprising the steps of:
receiving personal profile data from a plurality of participants, wherein each participant is a member of a virtual community;
generating a participant profile for each of the participants as a function of the personal profile data corresponding to each participant;
rating each participant as a function of an activity level within the virtual community; and
providing additional features to participants achieving a pre-determined rating.

2. The method of claim 1, further comprising the steps of:
receiving invitation information from a first participant corresponding to a second participant that the first participant desires to contact; and
sending an invitation to the second participant, the invitation including identification information corresponding to the first participant.

3. The method of claim 2, further comprising the step of:
associating the first participant with the second participant when the second participant accepts the invitation.

4. The method of claim 3, wherein the associating step includes associating the first and second participants with a sub-community within the virtual community.

5. The method of claim 2, wherein the invitation information includes a gift to be sent to the second participant and the gift is included in the invitation.

6. The method of claim 1, wherein the virtual community is a simulation of an actual social setting.

7. The method of claim 1, wherein the personal profile data includes one of a participant identification code, a password, an assumed role, a physical trait, a skill, a personality trait, a message, a photograph and billing details.

8. The method according to claim 1, wherein the activity level is measured by an amount of gifts acquired from a virtual gift shop within the virtual community.

9. The method according to claim 8, wherein the gifts include one of tangible gifts, virtual representations of actual gifts and the additional features.

10. The method according to claim 9, wherein the virtual representations of actual gifts include one of an image, a video, an icon and an audio clip.

11. The method according to claim 1, wherein the additional features include one of increased storage space within the virtual community, premium games, pre-requisite items for other features within the virtual community and placing the participant in a prominent location of a user interface for the virtual community.

12. The method of claim 1, further comprising the steps of:
receiving contact information from a first participant, the contact information relating to a potential participant for the virtual community; and
sending an invitation to the potential participant, the invitation being at least partially based on the contact information.

13. A system, comprising:
a registration element configured to receive personal profile data from a plurality of participants, wherein each participant is a member of a virtual community;
a profile element configured to generate a participant profile for each of the participants as a function of the personal profile data corresponding to each participant; and
a rating element configured to rate each participant as a function of an activity level within the virtual community; wherein additional features are accessible to participants achieving a pre-determined rating.

14. The system of claim 13, further comprising:
an invitation element configured to receive invitation information from a first participant corresponding to a second participant that the first participant desires to contact and to send an invitation to the second participant, the invitation including identification information corresponding to the first participant.

15. The system of claim 14, further comprising:
an association element configured to associate the first participant with the second participant in a sub-community within the virtual community when the second participant accepts the invitation.

16. The system of claim 14, wherein the invitation information includes a gift to be included in the invitation and sent to the second participant by the invitation element.

17. The system of claim 13, wherein the virtual community is a simulation of an actual social setting.

18. The system of claim 13, wherein the personal profile data received by the registration element includes one of a participant identification code, a password, an assumed role, a physical trait, a skill, a personality trait, a message, a photograph and billing details.

19. The system of claim 13, wherein the activity level utilized by the rating element is measured by an amount of gifts acquired from a virtual gift shop within the virtual community.

20. The system of claim 13, wherein the additional features include one of increased storage space within the virtual community, premium games, pre-requisite items for other features within the virtual community and placing the participant in a prominent location of a user interface for the virtual community.

21. The system of claim 13, further comprising:
an expansion element configured to receive contact information from a first participant, the contact information relating to a potential participant for the virtual community and to send an invitation to the potential participant, the invitation being at least partially based on the contact information.

22. A method, comprising the steps of:
storing a plurality of virtual representations of actual gifts;
displaying the virtual representations;
receiving an order for one of the virtual representations from a participant in a virtual community;
charging the participant for the one of the virtual representations; and
fulfilling the order for the one of the virtual representations.

23. The method of claim 22, wherein the charging step includes:
obtaining a deposit from the participant prior to the receiving step; and
debiting an amount equal to a sales price of the one of the virtual representations from the deposit.

24. The method of claim 22, wherein the charging step includes:
obtaining payment information from the participant subsequent to the receiving step;
processing a charge to the participant in an amount equal to a sales price of the one of the virtual representations, wherein the charge is a request sent to a banking institution for a transfer of funds from the participant.

25. The method of claim 22, wherein the charging step includes:
obtaining billing information from the participant;
adding an amount equal to a sales price of the one of the virtual representations to a credit account of the participant;
generating periodically a bill for the total amount added to the credit account within a designated period; and
forwarding the bill to the participant based on the billing information.

26. The method of claim 22, wherein the fulfilling step includes:
transmitting via a communications network the one of the virtual representations to a giftee; and
modifying a profile of the giftee within a virtual community to record the order.

27. The method of claim 22, wherein the fulfilling step includes:
delivering the actual gift, which was represented by the one of the virtual representations, to the giftee by a delivery service; and
modifying a profile of the giftee within a virtual community to record the order.

28. The method of claim 22, wherein the fulfilling step includes:
granting the giftee access to additional features, which were denoted by the one of the virtual representations; and
modifying a profile of the giftee within a virtual community to record the order.

27. The method according to claim 22, wherein the virtual representations are displayed in at least two languages.

28. The method according to claim 22, wherein the charging of the participant is based on a currency selected by the participant.
